(19) United States
(12) Patent Application Publication
(10) Pub. No.: US 2026/0070502 A1
(43) Pub. Date: Mar. 12, 2026

(54) SYSTEM AND METHOD FOR EMPATHETICALLY CONTROLLING IN-VEHICLE INFOTAINMENT UNITS TO PROVIDE IN-CABIN COMFORT AND SAFETY

(71) Applicant: L&T Semiconductor Technologies Limited, Mumbai (IN)

(72) Inventor: Vibhu Sharma, Austin, TX (US)

(21) Appl. No.: 19/314,399

(22) Filed: Aug. 29, 2025

Related U.S. Application Data
(60) Provisional application No. 63/692,723, filed on Sep. 10, 2024.

(51) Int. Cl. B60R 16/037; B60K 35/26; B60K 35/28; B60W 40/08; B60W 50/14; H04W 4/40

(52) U.S. Cl. CPC B60R 16/037; B60K 35/26; B60K 35/28; B60W 40/08; B60W 50/14; H04W 4/40; B60K 2360/164; B60W 2040/0872; B60W 2420/408; B60W 2420/54

(57) ABSTRACT

An embodiment herein provides a system for empathetically controlling in-vehicle infotainment units to enhance in-cabin comfort and safety. The system comprises a microphone array, a radar transceiver array, a deep learning processor, an infotainment processor, a cabin domain controller, and Vehicle-to-Everything (V2X) connectivity. The microphone array captures occupant audio signals, while the radar transceiver detects radio frequency (RF) signals within the vehicle cabin. The deep learning processor processes these signals to enhance speech, filter noise, and track movement, determining physiological parameters such as respiration rate, heart rate, cognitive skills, drowsiness, and emotional states. By implementing Doppler-assisted audio beamforming, the system creates personalized audio zones, adapting the cabin environment based on occupant well-being and preferences. The infotainment processor dynamically controls in-vehicle units in response to these parameters, while V2X connectivity enables interaction with external networks, enhancing overall vehicle safety and comfort.

### CROSS REFERENCE TO RELATED APPLICATIONS

This application claims priority to U.S. Provisional Patent Application No. 63/692,723, filed Sep. 10, 2024, the entire disclosure of which is incorporated herein by reference.

### TECHNICAL FIELD

Embodiments of present disclosure generally relate to improvement in in-cabin comfort and safety in vehicles, and more particularly to a system and method for empathetically controlling in-vehicle infotainment units using audio and radar technologies combined with deep learning processing for personalized experiences and enhanced safety.

### DESCRIPTION OF THE RELATED ART

With the advent of advanced autonomous driving technologies, particularly in Level 3+ autonomous vehicles, the role of in-cabin systems has evolved significantly. Traditional vehicle systems have primarily focused on functional aspects such as navigation, entertainment, and safety features. However, as vehicles become more autonomous, there is an increasing need to prioritize comfort, safety, and wellbeing of occupants in a more holistic and empathetic manner.

In Level 3+ autonomous vehicles, human driver is not always required to be in control, which introduces new challenges related to driver and passenger monitoring. Understanding physiological and emotional state of the driver and passengers becomes critical to ensure safety and enhance an overall driving experience. Traditional in-cabin systems that rely heavily on visual cues, such as cameras, often face limitations. However, these systems can struggle in varying lighting conditions or when visual obstructions are present, leading to less accurate or delayed responses.

Furthermore, conventional in-cabin sensing technologies, which include cameras and basic audio sensors, have limited capabilities when it comes to capturing and analyzing physiological data. For instance, radar sensors, while effective in certain scenarios, may lack accuracy in detecting specific physiological parameters, especially when occupants are speaking or in motion. Similarly, audio systems can be challenged by cabin noise, engine noise, and external environmental sounds, making it difficult to capture clear audio signals that could be used to monitor occupant wellbeing.

Current in-cabin comfort and safety solutions have attempted to address these challenges through a mix of safety and non-safety use cases. Safety-driven features, such as drowsiness detection, distraction monitoring, and emergency reporting, have become essential, particularly in response to emerging regulations. However, these systems often operate in isolation and lack the integration necessary to provide a seamless and personalized in-cabin experience.

Non-safety features, such as dynamic adaptation of the vehicle's environment based on data from biological and environmental sensors, offer value-added propositions but are often constrained by the limitations of existing sensor technologies. For example, multiple microphones positioned throughout the cabin can enhance audio capture, but they introduce cost and heat dissipation challenges. Audio Digital Signal Processing (DSP) systems, while capable of noise cancellation, struggle with the complexity of filtering out multiple sources of noise within the cabin.

Accordingly, there is a need for a more integrated system that combines different sensing modalities such as audio and radar into a unified system capable of providing an empathetic in-cabin experience.

### SUMMARY

Embodiments of the present disclosure generally relate to improvement in in-cabin comfort and safety in vehicles, and more particularly to a system and method for empathetically controlling in-vehicle infotainment units using audio and radar technologies combined with deep learning processing for personalized experiences and enhanced safety.

In an aspect, the present disclosure relates to a system for empathetically controlling an in-vehicle environment. The system comprises a microphone array configured to capture audio signals in the in-vehicle environment, a radar transceiver array configured to detect radio frequency (RF) signals in the in-vehicle environment, a deep learning processor communicatively coupled to the microphone array and the radar transceiver array, and a memory operatively coupled with the deep learning processor. Said memory stores instructions which, when executed by the deep learning processor, cause the system to analyze perturbations in the detected RF signals to determine a precise location of at least one occupant within a vehicle cabin. Thereafter, the system utilizes the determined precise location to direct the microphone array to capture a location-specific audio signal from the at least one occupant. From these inputs, the system determines a physiological state of the at least one occupant by analyzing at least one of the detected RF signals and the location-specific audio signal. Based on the determined physiological state, the system ultimately generates a control signal to perform at least one of empathetically adjust one or more in-vehicle infotainment units, generate an alert for attention of the at least one occupant in the in-vehicle environment, or provide a personalized three-dimensional (3D) audio experience to the at least one occupant via Doppler-assisted audio beamforming.

In an aspect, the present disclosure relates to a method for empathetically controlling an in-vehicle environment. The method includes detecting, via a radar transceiver array, radio frequency (RF) signals in the in-vehicle environment. The method includes analyzing, by a deep learning processor, perturbations in the detected RF signals to determine a precise location of at least one occupant within a vehicle cabin. Thereafter, the method includes utilizing, by the deep learning processor, the determined precise location to direct a microphone array to capture a location-specific audio signal from the at least one occupant. The method further includes subsequently determining, by the deep learning processor, a physiological state of the at least one occupant by analyzing at least one of the detected RF signals and the location-specific audio signal. Furthermore, the method includes generating, by the deep learning processor and based on the determined physiological state, a control signal to perform at least one of empathetically adjusting one or more in-vehicle infotainment units, generating an alert for attention of the at least one occupant in the in-vehicle environment, or providing a personalized three-dimensional (3D) audio experience to the at least one occupant via Doppler-assisted audio beamforming.

### BRIEF DESCRIPTION OF THE DRAWINGS

The embodiments herein will be better understood from the following detailed description with reference to the drawings, in which:

FIG. 1 illustrates a block diagram of a system that empathetically controls in-vehicle infotainment units for providing in-cabin comfort and safety, according to an embodiment herein;

FIG. 2 illustrates an exploded view of the system of FIG. 1, according to an embodiment herein;

FIG. 3 illustrates an exploded view of a deep learning processor of the system of FIG. 1, according to an embodiment herein; and

FIG. 4 illustrates a flowchart of a method for empathetically controlling in-vehicle infotainment units to provide in-cabin comfort and safety, according to an embodiment herein.

### DETAILED DESCRIPTION OF PREFERRED EMBODIMENTS

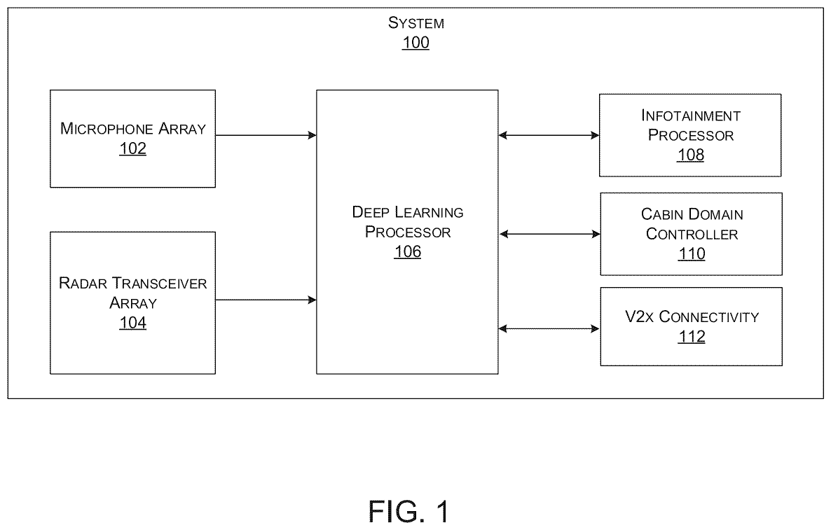

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein. As mentioned, there remains a need for a system that empathetically controls in-vehicle infotainment units for providing in-cabin comfort and safety. Referring now to the drawings, and more particularly to FIGS. 1 through 4, where similar reference characters denote corresponding features consistently throughout the figures, there are shown preferred embodiments.

FIG. 1 illustrates a block diagram of a system 100 that empathetically controls in-vehicle infotainment units for providing in-cabin comfort and safety, according to an embodiment herein. The system 100 includes a microphone array 102, a radar transceiver array 104, a deep learning processor 106, an infotainment processor 108, a cabin domain controller 110, and a Vehicle-to-Everything (V2X) connectivity module 112. The microphone array 102 may be configured to capture audio signals from at least one occupant within a vehicle cabin. The occupant may be a driver or a passenger. The radar transceiver array 104 may be configured to detect radio frequency (RF) signals of the at least one occupant within the vehicle cabin. The deep learning processor 106 may be communicatively connected to the microphone array 102 and the radar transceiver array 104, and a memory storing instructions which, when executed, may cause the system 100 to perform sequence of steps via the deep learning processor 106.

The deep learning processor 106 may receive the captured audio signals of the at least one occupant from the microphone array 102 and may receive the detected RF signals from the radar transceiver array 104. The deep learning processor 106 may be configured to process the captured audio signals to enhance speech and to filter noise in the audio signals. The deep learning processor 106 may be further configured to process the detected RF signals to track movement and determine physiological parameters of the at least one occupant within the vehicle cabin. For example, the system 100 may employ advanced signal processing and deep learning techniques to analyze variations in the RF signals as they interact with the at least one occupant and the surrounding environment. The deep learning processor 106 may leverage RF signals, such as RF signals emitted by Wireless-Fidelity (Wi-Fi), Bluetooth, or other radio-frequency sources, to monitor the vehicle cabin. As the RF signals propagate within the vehicle cabin, the RF signals undergo changes due to reflection, diffraction, and scattering caused by the occupant's presence and movement, which may be referred to as alterations in the RF signals. The alterations in the RF signals may be captured and analyzed by the system 100 to detect the occupant's activities and physiological state. The system 100 may analyse perturbations, which includes any of alterations or shifts such as for instances phase, amplitude, and frequency in the detected RF signals by analysing at least one of Channel State Information (CSI) or Received Signal Strength (RSS) data in the detected RF signals.

The deep learning processor 106 may determine channel state information (CSI) which provides detailed information about the RF signal's transmission path, including changes in amplitude and phase. The channel state information (CSI) may be highly sensitive to variations in the environment caused by the occupant's movements. The deep learning processor 106 may analyze the received signal strength (RSS) and measure the power level of the received RF signal, which fluctuates based on the distance and obstacles in the signal path, including the occupant's body. The deep learning processor 106 identifies and tracks the occupant's movements by analyzing perturbations in the RF signals. The occupant's movements, such as sitting, standing, or reaching, cause detectable changes in the RF signal's phase and amplitude. The deep learning processor 106 may be trained to recognize specific movement patterns from the temporal variations in the RF signals. By analyzing specific movement patterns, the system 100 can determine the occupant's actions and positions within the vehicle cabin.

The deep learning processor 106 may also monitor physiological parameters of the at least one occupant using RF signal analysis. Subtle movements related to breathing and heartbeats may cause small modulations in the RF signals, which can be detected by the system 100 and analyzed to monitor physiological parameters of the occupant. The deep learning processor 106 may further detect frequency shifts in the detected RF signals, which is caused by repetitive motions, such as for instance the chest movements during respiration or the heartbeat. The deep learning processor 106 may process frequency shifts to estimate the occupant's heart rate and respiratory rate. The deep learning processor 106 may extract features from the CSI and RSS data that correlate with specific movements and physiological parameters.

In some embodiments, the deep learning processor 106 may be trained on datasets containing the parameters of RF frequency shifts or modulations, which enable the deep learning processor 106 to accurately map the detected RF signal changes to the occupant's activities and physiological states. The deep learning processor 106 may continuously monitor and classify the occupant's activities (e.g., sitting, moving, resting) and may further track their physiological parameters (e.g., heart rate, breathing rate) in real-time. In response to the detected physiological parameter, the system 100 via the deep learning processor 106, may also generate an alert in response to detection of unusual patterns in the physiological state/parameters of the occupant, to enhance occupant's safety and comfort.

The physiological parameters may include respiration rate and effort of the occupant, heart rate and heart health of the occupant, cognitive skills of the occupant, drowsiness of the occupant, distraction of the occupant and emotion state of the occupant such as for instance, rage of the occupant, etc. In some embodiments, the system 100 may determine the physiological state of the at least one occupant by analyzing at least one of the detected RF signals and a location-specific audio signal, and based on the determined physiological state, generate a control signal via the deep learning processor 106, to perform at least one of empathetically adjust one or more in-vehicle infotainment units, generate an alert for attention of the at least one occupant in the in-vehicle environment, or provide a personalized three-dimensional (3D) audio experience to the at least one occupant via Doppler-assisted audio beamforming.

In some embodiments, the deep learning processor 106 may be configured to implement a doppler to assist audio beamforming to create personalized audio zones for the occupant within the vehicle cabin. The personalized audio zone may provide the audio experience to individual preferences while minimizing unwanted noise. In other words, the personal audio zones may allow the individual adjustment of sound setting (in particular volume) for the multiple listeners in close vicinity.

The personalized audio zone may refer to personalized sound spaces, may also be referred to as ‘personalized audio zones’, for the occupant present in the vehicle cabin. The personalized audio zones may be generated by precisely controlling direction of the sound, to ensure that each occupant hears only the audio sound intended for them without interference from surrounding noise. The system 100 may generate the personalized sound spaces for each of the occupant by strategically placing sound sources and leveraging the spatial characteristics of ambient noise. The system 100, using the deep learning processor 106, ensures that the audio sound intended for each of the occupant is clear and localized. The process of localizing the audio sound for each of the occupant within the vehicle cabin may provide personalized three-dimensional (3D) audio experience. The personalized 3D approach may enhance the listening experience for each of the occupant, making the experience feel more immersive and focused. Unlike traditional methods that require ear-covering devices, the personal audio zones may employ a plurality of speakers which may also be referred to as ‘speaker arrays’.

The speaker arrays may be designed and arranged effectively to reduce external noise without the need to block the ears. This allows for an open-ear experience where unwanted sounds are suppressed, and the desired audio is delivered directly to each of the occupants. Further, the personal audio zones enable a highly personalized, immersive, and health-conscious audio experience within the vehicle cabin, allowing each occupant to enjoy their preferred audio content without distractions.

In some embodiments, the deep learning processor 106 may further be configured to receive the captured audio signals in the in-vehicle environment from the occupants. Based on the analyzed modulation, perturbations, and frequency shifts present in the detected RF signals, the system 100, using the deep learning processor 106, may determine a precise location of the at least one occupant within the vehicle cabin. The deep learning processor 106 may utilize the determined precise location of each of the occupant present in the vehicle cabin to direct the microphone array 102 to capture the location-specific audio signal from one or more occupants in the vehicle cabin. The deep learning processor 106 may further determine the physiological state of the at least one occupant by analyzing at least one of the detected RF signals and the location-specific audio signal.

The deep learning processor 106 may extract vocal biomarkers present in the location-specific audio signal coming from the one or more occupant present in the vehicle cabin. The deep learning processor 106 may determine the respiration rate and heart rate of each of the occupant by analyzing vocal biomarkers present in the respective audio signals received from each occupant's location within the vehicle cabin. The deep learning processor 106 may analyze the characteristics of each of the received audio signals to identify the vocal biomarkers present in the received audio signals. The system 100, rather than using a general audio signal from the entire cabin, may isolate the audio signals. Based on their location of origin, the audio signals may be referred to location specific audio signals, in other words, the system 100 may isolate the received audio signals based on each occupant's distinct location within the vehicle cabin.

In some embodiments, the deep learning processor 106 may use the analyzed vocal biomarkers of each of the occupants as a non-invasive physiological health indicator. The system 100 may leverage an artificial intelligence and speech processing to extract physiological information embedded within the voice. By analyzing vocal biomarkers, the deep learning processor 106 can estimate respiration and heart rates of each of the occupant without the need for physical sensors. The deep learning processor 106 may detect the respiratory patterns from regular speech, with an approximate accuracy of +/−3 breaths per minute for over 85% of subjects/occupants. The technique of detecting the respiratory patterns avoids the motion artifacts, subject variability, and privacy concerns associated with traditional sensor-based approaches.

In some embodiments, the deep learning processor 106 may employ techniques that effectively manage the complexities of real-world scenarios, such as plurality of speakers, varying signal-to-noise ratios, and ambient noise within the vehicle cabin. The system 100 may be extended speech-based sensing to other vital signs, thereby enhancing the ability to monitor occupant health and personalize in-cabin experiences based on physiological data.

In some embodiments, the microphone array 102 may be configured to mitigate the effects of the vehicle cabin noise, engine noise, and external noise for clear speech signal processing. In some embodiments, the radar transceiver array 104 may be configured to operate under varying lighting conditions and to overcome occlusions within the vehicle cabin.

The infotainment processor 108 may be configured to control one or more in-vehicle infotainment units based on the physiological parameters of the occupant. For example, if the system 100, detects that the occupant is stressed, indicated by analysis of occupant's physiological parameters, such as an elevated respiration rate, the infotainment processor 108 may respond by streaming calming music or activating the seat massager. In some embodiments, the infotainment processor 108 may be further configured to dynamically adapt the vehicle cabin environment based on the physiological parameters and preferences of the occupant.

The system 100 may further include the Vehicle-to-Everything (V2X) connectivity module 112 to interact with external networks. The external networks may establish a plurality of communication links, such as Vehicle-to-Vehicle (V2V), Vehicle-to-Infrastructure (V2I), Vehicle-to-Pedestrian (V2P), and Vehicle-to-Network (V2N). The deep learning processor 106, upon determining a critical physiological state for the occupant, may generate the alert via the control signal. The alert may be transmitted to the external network via the Vehicle-to-Everything (V2X) connectivity module 112.

In some embodiments, the cabin domain controller 110 may be configured to integrate and manage the components of the in-vehicle infotainment units.

The system 100 may combine occupant's audio signals with radar-detected RF signals to generate a comprehensive dataset representing occupants' physiological parameters/state. By utilizing the doppler-assisted audio beamforming technique, the system 100 may create high-fidelity personalized audio zones, significantly enhancing the in-cabin audio experience. Additionally, the deep learning processor 106 may enable advanced speech enhancement, noise cancellation, and real-time analysis of vocal biomarkers, to provide a more accurate assessment of the occupants' wellbeing/health.

Moreover, the system 100 may be designed to operate effectively under a wide range of conditions, including varying lighting scenarios and potential visual obstructions. This makes it particularly well-suited for the demanding environment of Level 3+ autonomous vehicles, where the ability to respond quickly and accurately to the needs of the driver and passengers is paramount.

The system 100 not only improves safety and comfort but also provides a new generation of empathetic in-cabin systems that are capable of understanding and responding to the unique needs of each occupant. This empathetic system would not only enhance safety by accurately detecting and responding to the physiological state of the occupant but also improve comfort by creating personalized environments tailored to individual needs and preferences.

The system 100 addresses these needs by introducing a multi-modal system that leverages audio and radar technologies in conjunction with deep learning processing. The system 100 is designed to overcome the limitations of existing in-cabin solutions by providing robust and accurate physiological sensing, personalized audio experiences, and dynamic control of the in-vehicle environment.

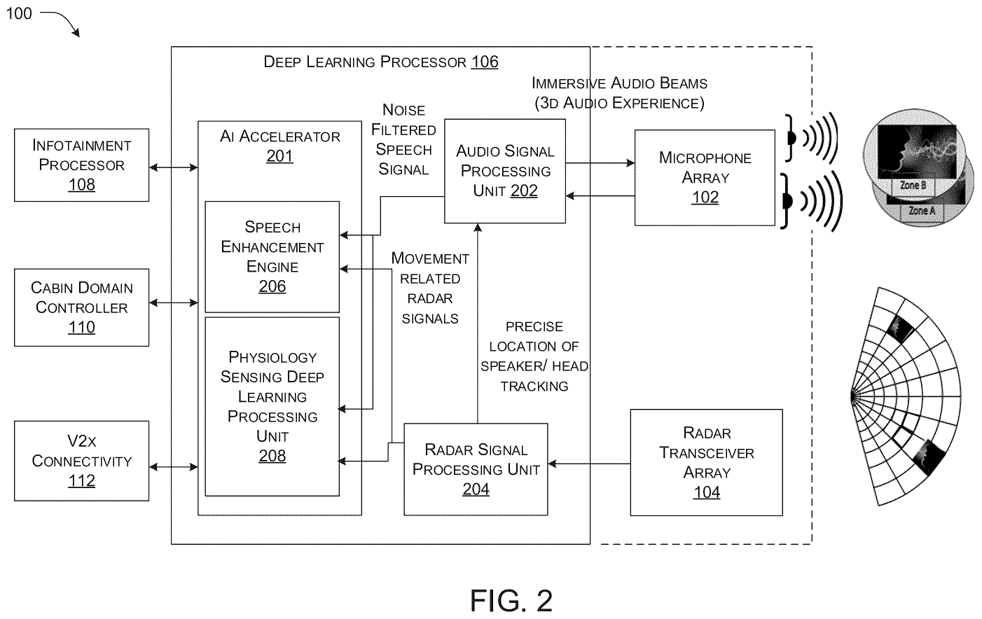

FIG. 2 illustrates an exploded view of the system 100 of FIG. 1, according to an embodiment herein. The system 100 includes the microphone array 102, the radar transceiver array 104, the deep learning processor 106, the infotainment processor 108, the cabin domain controller 110, and the Vehicle-to-Everything (V2X) connectivity module 112. The microphone array 102 is configured to capture audio signals of the occupant within the vehicle cabin. The microphone array 102 may be strategically placed to ensure optimal audio capture from various zones within the vehicle cabin. The microphone array 102 may collect audio signals/voice inputs from the occupant, which are then processed to create immersive audio experiences and to facilitate speech recognition.

The radar transceiver array 104 may be configured to detect radio frequency (RF) signals of the occupant within the vehicle cabin to detect movement and physiological parameters of the occupants present in the vehicle cabin. The physiological parameters may include respiration rate and effort of the occupant, heart rate and heart health of the occupant, cognitive skills of the occupant, drowsiness of the occupant, distraction of the occupant, emotion state of the occupant, etc. The radar transceiver array 104 may capture fine-grained details, indicating physiological parameters of the occupant such as heart rate, breathing patterns, and even subtle head movements, which are crucial for understanding the physical and emotional state of the occupant.

The deep learning processor 106 communicatively connected to the microphone array 102 and the radar transceiver array 104 may receive the captured audio signals of the occupant from the microphone array 102 and the detected RF signals from the radar transceiver array 104. The deep learning processor 106 may be configured to process the captured audio signals to enhance speech and to filter noise in the audio signals. The deep learning processor 106 may achieve this by differentiating the unique patterns of human speech from background noise and isolating the desired speech/audio signal from other noises. The deep learning processor 106 may be further configured to process the detected RF signals to track movement and determine physiological parameters of the occupant within the vehicle cabin. This can be achieved by the deep learning processor 106, by identifying the impacts of body movements on distorting the reflected RF signals and detecting the minuscule, rhythmic patterns caused by the occupant's breathing and heartbeats.

In some embodiments, the deep learning processor 106 includes an audio signal processing unit 202 and a radar signal processing unit 204. The audio signal processing unit 202 may receive the captured audio signals from the microphone array 102 and filter out noise from the captured audio signals. The deep learning processor 106 may accomplish noise filtering by distinguishing the acoustic patterns of occupant's speech/audio signals from various background interferences. In some embodiments, the audio signal processing unit 202 may receive precise location data of the occupant's head from the radar signal processing unit 204. The audio signal processing unit 202 may generate immersive audio beams that create a 3D audio experience tailored to the personalized audio zones within the vehicle cabin. The audio signal processing unit 202 may transform the audio signals into 3D sound. The personalized audio zones may be generated by using the speaker arrays to perform audio beamforming, where the 3D sound is directed narrowly to form focused beams, and the focused beams may be sent using speaker arrays to the precise location of the occupant. The 3D immersive audio beams ensure that the occupant experiences high-fidelity audio personalized to their seating position. In some embodiments, the microphone array 102 may be configured to mitigate the effects of vehicle cabin noise, engine noise, and external noise for clear speech signal processing. Beamforming techniques may be used to electronically ‘steer’ its listening focus towards the occupant who is speaking, thereby reducing the pickup of ambient sounds from other directions.

In some embodiments, the radar signal processing unit 204 may interpret the received radar signals from the radar transceiver array 104. The radar signal processing unit 204 may detect each occupant's movement and their respective physiological parameters. The radar signal processing unit 204 may determine the precise location of the occupant's head and track their movement by calculating the RF signal's range including travel time and Angle of Arrival (AoA), and phase differences across radar transceiver array 104. The combination of range and angle data may generate a 3D map of the cabin, allowing the deep learning processor 106 to identify and continuously track the cluster of reflection points that correspond to the occupant's head and body. The detected movement and physiological parameters of the occupant are fed into both the audio signal processing unit 202 to adjust audio beams and the deep learning processor 106 to enhance physiological parameters monitoring. In some embodiments, the radar transceiver array 104 may be configured to operate under varying lighting conditions and overcome occlusions within the vehicle cabin.

The deep learning processor 106 may further include an artificial intelligence (AI) accelerator 201. The AI accelerator 201 may support a speech enhancement engine 206 and a physiology sensing deep learning processing unit 208, ensuring real-time data processing and decision-making. The speech enhancement engine 206 may process the noise-filtered audio signals received from the audio signal processing unit 202. In some embodiments, noise-filtered audio signals may be received directly from the microphone array 102. The speech enhancement engine 206 may be configured to enhance speech clarity, and extract relevant speech features. The enhanced speech signals may be used for further processing, including communication with external systems through the Vehicle-to-Everything (V2X) connectivity module 112 of the system 100. The physiology sensing deep learning processing unit 208 analyzes the RF signals related to the occupants' physiological parameters/states. The physiology sensing deep learning processing unit 208 may process occupant's movement-related data in detected RF signals to further detect changes in heart rate, breathing, and other vital signs. The output from the physiology sensing deep learning processing unit 208 may determine the physiological state and emotion state of the occupant.

In some embodiments, the cabin domain controller 110 may be configured to integrate and manage the various components of the in-vehicle infotainment units, including climate control, seating adjustments, and lighting. The cabin domain controller 110 may interact with the deep learning processor 106 to adjust the in-vehicle infotainment units dynamically, based on the physiological parameters and comfort requirements of the occupant. The system 100 using the deep learning processor 106, may empathetically adjust the in-vehicle environment by modifying at least one of a climate control setting, a seat setting, or a lighting setting via the cabin domain controller (110) associated with the system (100).

In some embodiments, the deep learning processor 106 may be further configured to analyze vocal biomarkers to determine the emotional state or stress level of the occupant, while physiological parameters such as respiration rate and heart rate may be determined by analyzing the detected RF signals and the vocal biomarkers.

In some embodiments, the infotainment processor 108 may be configured to control one or more in-vehicle infotainment units based on the physiological parameters of the occupant. In some embodiments, the infotainment processor 108 may be further configured to dynamically adapt the vehicle cabin environment based on the physiological parameters and preferences of the occupant.

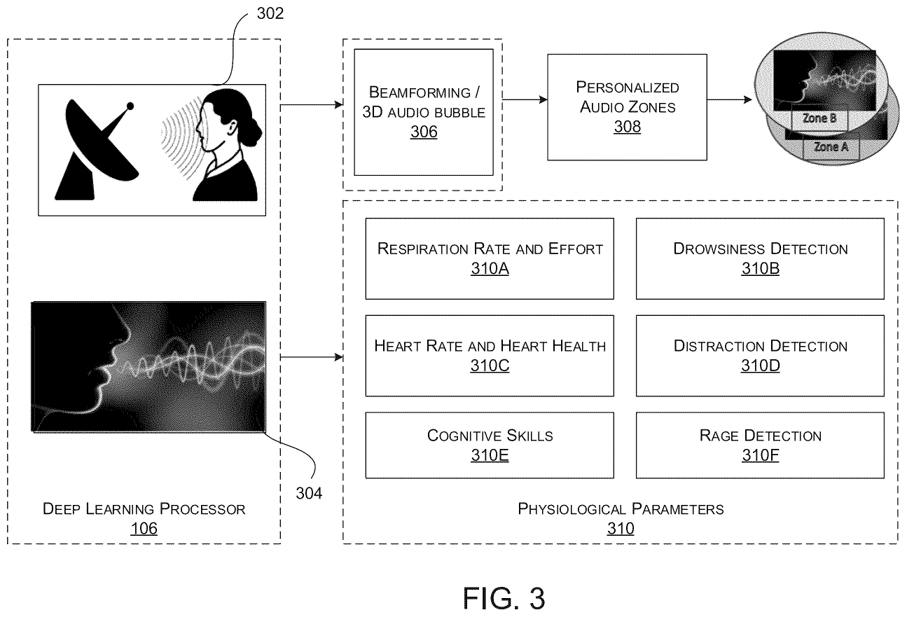

FIG. 3 illustrates an exploded view of the deep learning processor 106 of the system 100 of FIG. 1, according to an embodiment herein. The deep learning processor 106 may be configured to process the captured audio signals to enhance speech and to filter noise in the audio signals. The deep learning processor 106 may be configured to process the detected RF signals to track movement and determine physiological parameters 310 of the occupant within the vehicle cabin. The physiological parameters 310 may include at least one of the respiration rate 310A, the drowsiness level 310B, the heart rate 310C, the distraction level 310D, cognitive skills 310E, and an emotional state such as rage 310F of the at least one occupant. The system 100 may determine the physiological state of the occupant by detecting and analyzing perturbations or modulations in the detected RF signals, where such perturbations may include phase, amplitude and frequency shift caused by subtle movements (e.g. chest movements) of the at least one occupant.

The deep learning processor 106 may serve as a central unit for interpreting data and controlling the system's 100 operations. The deep learning processor 106 implements a doppler 302 to assist audio beamforming to create personalized audio zones 308 for each of the occupant within the vehicle cabin. The dynamic personalized audio zones may be created by using the Doppler shifts detected in the RF signals from the radar transceiver array 104 to precisely track the occupant's head position in three-dimensional space in real-time. The dynamic positional data may be used by the deep learning processor 106 to continuously steer a focused audio beam from the speaker arrays, directly towards each of the occupant, ensuring that the personalized audio zone remain accurately targeted even as the occupant moves.

In some embodiment, the radar transceiver array 104 may be a Doppler based radar transceiver, which may detect RF signals in the vehicle cabin. The deep learning processor 106 may receive and process the detected RF signals from the doppler based radar transceiver 302 and the vocal biomarkers 304 representing occupant's vocal inputs/audio signals characteristics, to determine the occupants' physiological parameters and emotional states. The deep learning processor 106 may also determine the plurality of physiological parameters, such as respiration rate, heart rate, and cognitive skills, to enhance the system's 100 functionality.

The system 100 may utilize the doppler radar transceiver array 104 to detect the occupant's movement and a velocity of that occupants' body parts movement, including head and limb movements. The radar signals from the doppler 302 may determine the position and orientation of each occupant in the vehicle cabin.

In some embodiment, the system 100 applies doppler assisted audio beamforming techniques to create a 3D audio bubble 306 around each occupant. The 3D audio bubble 306 provides a personalized audio experience, ensuring that the audio delivered to each occupant is optimized for their specific location and orientation. The 3D audio bubble 306 is dynamically adjusted based on real-time movements detected by the radar signals from the doppler 302, creating a highly immersive and individualized listening experience.

The 3D audio bubble 306 defines personalized audio zones 308 within the vehicle cabin. Each personalized audio zone 308 is tailored to the preferences and current state of the occupant, offering customized soundscapes that enhance comfort and satisfaction during the ride. For example, one occupant may experience calming music in one zone, while another enjoys a livelier auditory environment in a different zone.

The system 100 monitors a range of physiological parameters 310, utilizing inputs from both, the Doppler 302 and the vocal biomarkers 304. The deep learning processor 106 analyzes these inputs to assess the occupants' health and well-being. The doppler based RF signals 302 may detect the subtle movements associated with breathing of the occupant. By analyzing the frequency and intensity of these subtle movements, the system 100 can monitor respiration rate and effort, providing insights into the occupant's stress levels or physical discomfort. The system 100 uses the received RF signals to detect heartbeat-related movements, allowing the system 100 to estimate occupant's heart rate and assess heart health. The deep learning processor 106 uses this information to detect potential health issues or changes in the occupant's emotional state, such as anxiety or calmness.

By analyzing vocal inputs and physiological parameters, the system 100 can infer the cognitive state of the occupants. For instance, the system 100 can detect signs of cognitive fatigue or alertness, helping to maintain optimal mental performance during the ride. The system 100 may continuously monitor eye movements, blinking rates, and head nodding through RF signals and vocal biomarkers to detect signs of other physiological state related to the occupant such as for instance drowsiness. The system 100, using the physiology sensing deep learning processing unit 208, detect the drowsiness, the system 100 may take preventive actions, such as alerting the driver or adjusting the in-cabin environment to help keep the driver awake.

In some embodiment, the system 100 may track head and eye movements of the occupant to determine if the driver or other occupants are distracted. If a distraction is detected, the system 100 can issue warnings or adjust the audio environment to refocus the occupant's attention.

In some embodiment, by analysing vocal tone, speech patterns, and physiological parameters such as heart rate and respiration, the system 100 can detect signs of rage or extreme agitation. If rage is detected, the system 100 can respond by modifying the vehicle cabin environment to help calm the occupant, potentially reducing the risk of aggressive behavior or unsafe driving.

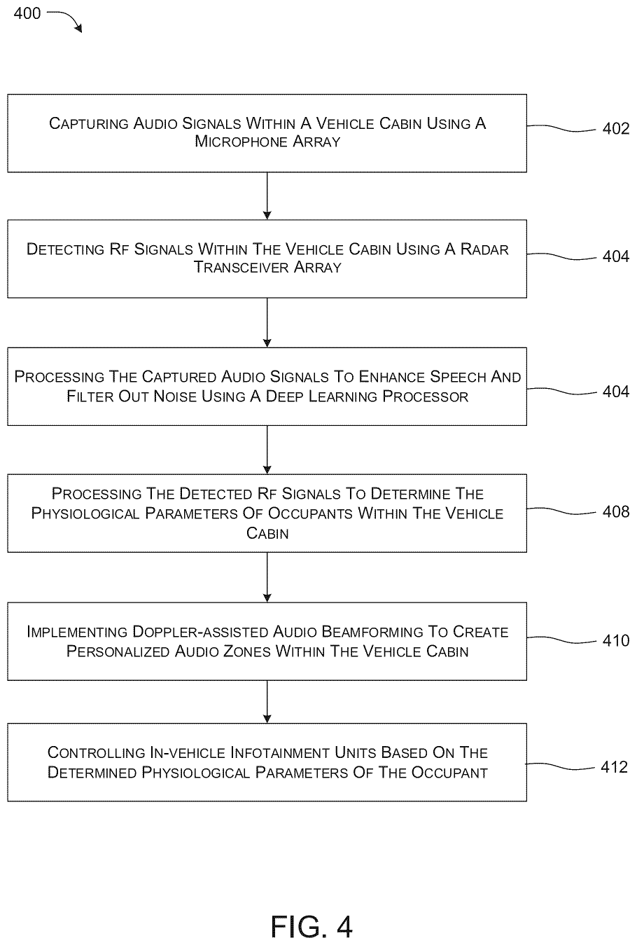

FIG. 4 illustrates a flowchart of a method 400 for empathetically controlling in-vehicle infotainment units to provide in-cabin comfort and safety, according to an embodiment herein. At step 402, audio signals are captured within the vehicle cabin using the microphone array 102. At step 404, RF signals are detected within the vehicle cabin using the radar transceiver array 104. At step 406, the captured audio signals are processed to enhance speech and filter out noise using the deep learning processor 106. At step 408, the detected RF signals are processed to determine physiological parameters of the occupant within the vehicle cabin. At step 410, a doppler-assisted audio beamforming is implemented to create personalized audio zones within the vehicle cabin. At step 412, in-vehicle infotainment units are controlled based on the determined physiological parameters of the occupant.

In some embodiment, the method 400 may include determine a physiological state of the at least one occupant by analyzing at least one of the detected RF signals and the location-specific audio signal, and based on the determined physiological state, generate a control signal to perform at least one of: empathetically adjust one or more in-vehicle infotainment units, generate an alert for attention of the at least one occupant in the in-vehicle environment or provide a personalized three-dimensional (3D) audio experience (308) to the at least one occupant via Doppler-assisted audio beamforming.

In some embodiments, the method 400 analyzes vocal biomarkers 304 to determine the respiration rate and heart rate of the occupant. In some embodiments, the method 400 mitigates the effects of vehicle cabin noise, engine noise, and external noise during the speech signal processing.

In some embodiments, the method 400 dynamically adapts the vehicle cabin environment based on the physiological parameters and preferences of the occupant. In some embodiments, the radar transceiver array 104 operates under varying lighting conditions and overcomes occlusions within the vehicle cabin.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope.

We claim:

1. A system for empathetically controlling an in-vehicle environment, the system comprising:
a microphone array configured to capture audio signals in the in-vehicle environment;
a radar transceiver array configured to detect radio frequency (RF) signals in the in-vehicle environment;
a deep learning processor communicatively coupled to the microphone array and the radar transceiver array; and
a memory operatively coupled with the deep learning processor, wherein said memory stores instructions which, when executed by the deep learning processor, cause the system to:
analyze perturbations in the detected RF signals to determine a precise location of at least one occupant within a vehicle cabin;
utilize the determined precise location to direct the microphone array to capture a location-specific audio signal from the at least one occupant;
determine a physiological state of the at least one occupant by analyzing at least one of the detected RF signals and the location-specific audio signal; and
based on the determined physiological state, generate a control signal to perform at least one of:
empathetically adjust one or more in-vehicle infotainment units;
generate an alert for attention of the at least one occupant in the in-vehicle environment; or
provide a personalized three-dimensional (3D) audio experience to the at least one occupant via Doppler-assisted audio beamforming.

2. The system of claim 1, wherein the system empathetically adjusts the in-vehicle environment by modifying at least one of a climate control setting, a seat setting, or a lighting setting via a cabin domain controller associated with the system.

3. The system of claim 1, wherein the physiological state comprises at least one of: a respiration rate, a heart rate, a drowsiness level, a distraction level, or an emotional state of the at least one occupant.

4. The system of claim 1, wherein the system enhances the location-specific audio signal for clear communication via a Vehicle-to-Everything (V2X) module associated with the system.

5. The system of claim 1, wherein the system determines the physiological state by analyzing vocal biomarkers present in the location-specific audio signal.

6. The system of claim 1, wherein the system determines the physiological state by detecting and analyzing modulations in the detected RF signals caused by subtle chest movements of the at least one occupant.

7. The system of claim 1, wherein the personalized 3D audio experience comprises a 3D audio bubble that is dynamically adjusted based on real-time movements of the at least one occupant.

8. The system of claim 1, wherein upon generating the alert, the system transmits the alert to an external network via a Vehicle-to-Everything (V2X) connectivity module in response to a determination of a critical physiological state of the at least one occupant.

9. The system of claim 3, wherein the system determines the drowsiness level and the distraction level of the at least one occupant by tracking at least one of eye movements or head movements from the detected RF signals.

10. The system of claim 1, wherein the system analyzes perturbations in the detected RF signals by analyzing at least one of: Channel State Information (CSI) or Received Signal Strength (RSS) data in the detected RF signals.

11. A method for empathetically controlling an in-vehicle environment, the method comprising:
detecting, via a radar transceiver array, radio frequency (RF) signals in the in-vehicle environment;
analyzing, by a deep learning processor, perturbations in the detected RF signals to determine a precise location of at least one occupant within a vehicle cabin;
utilizing, by the deep learning processor, the determined precise location to direct a microphone array to capture a location-specific audio signal from the at least one occupant;
determining, by the deep learning processor, a physiological state of the at least one occupant by analyzing at least one of the detected RF signals and the location-specific audio signal; and
generating, by the deep learning processor and based on the determined physiological state, a control signal to perform at least one of:
empathetically adjusting one or more in-vehicle infotainment units;
generating an alert for attention of the at least one occupant in the in-vehicle environment; or
providing a personalized three-dimensional (3D) audio experience to the at least one occupant via Doppler-assisted audio beamforming.

12. The method of claim 11, wherein empathetically adjusting the in-vehicle environment comprises modifying at least one of a climate control setting, a seat setting, or a lighting setting via a cabin domain controller.

13. The method of claim 11, wherein the physiological state comprises at least one of: a respiration rate, a heart rate, a drowsiness level, a distraction level, or an emotional state of the at least one occupant.

14. The method of claim 11, further comprising enhancing the location-specific audio signal for clear communication via a Vehicle-to-Everything (V2X) module.

15. The method of claim 11, wherein determining the physiological state comprises analyzing vocal biomarkers present in the location-specific audio signal.

16. The method of claim 11, wherein determining the physiological state comprises detecting and analyzing modulations in the detected RF signals caused by subtle chest movements of the at least one occupant.

17. The method of claim 11, wherein providing the personalized 3D audio experience comprises creating a 3D audio bubble that is dynamically adjusted based on real-time movements of the at least one occupant.

18. The method of claim 11, further comprising transmitting the alert to an external network via a Vehicle-to-Everything (V2X) connectivity module in response to a determination of a critical physiological state of the at least one occupant.

19. The method of claim 13, wherein determining the drowsiness level and the distraction level of the at least one occupant comprises tracking at least one of eye movements or head movements from the detected RF signals.

20. The method of claim 11, wherein analyzing perturbations in the detected RF signals comprises analyzing at least one of: Channel State Information (CSI) or Received Signal Strength (RSS) data in the detected RF signals.
